(19) United States
(12) Patent Application Publication
(10) Pub. No.: US 2026/0208630 A1
(43) Pub. Date: Jul. 23, 2026

(54) METHOD FOR OPERATING A COMFORT SYSTEM OF A MOTOR VEHICLE, FOOTREST SYSTEM, COMFORT SYSTEM AND MOTOR VEHICLE

(71) Applicant: Brose Fahrzeugteile SE & Co. Kommanditgesellschaft, Coburg, Coburg (DE)

(72) Inventors: Joerg Gropp, Boehlen (DE); Tim Oschmann, Friedrichroda (DE); Jonas Scheler, Bad Rodach (DE); Gregor Kroener, Bischberg (DE)

(21) Appl. No.: 18/717,351

(22) PCT Filed: Nov. 28, 2022
(86) PCT No.: PCT/EP2022/083420

§ 371 Date: Jun. 6, 2024

(30) Foreign Application Priority Data
Dec. 7, 2021 (DE) 10 2021 132 191.3

(51) Int. Cl. B60N 2/02; B60N 2/12; B60N 3/06

(52) U.S. Cl. CPC B60N 2/0244; B60N 2/12; B60N 3/063

(57) ABSTRACT

Method for operating a comfort system of a motor vehicle, wherein the comfort system has a footrest system with a footrest for supporting the feet of a user, wherein the motor vehicle has a supporting structure which forms a stepped offset between a lower supporting plate and an upper supporting plate in a longitudinal direction, wherein, in the context of a comfort adjustment, the footrest is adjusted by means of a footrest adjustment system from a parked position on the lower supporting plate, over said stepped offset and into an operating position on the upper supporting plate, with the footrest changing inclination with respect to the longitudinal direction.

### CROSS-REFERENCE TO RELATED APPLICATIONS

This application is a national stage application under 35 U.S.C. 371 of International Patent Application Serial No. PCT/EP2022/083420, entitled “Method For Operating a Comfort System of a Motor Vehicle, Footrest System, Comfort system, and Motor Vehicle,” filed Nov. 28, 2022, which claims priority from German Patent Application No. DE 10 2021 132 191.3, filed Dec. 7, 2021, the disclosure of which is incorporated herein by reference.

### FIELD OF THE TECHNOLOGY

Embodiments provide a method for operating a comfort system of a motor vehicle, to a footrest system for carrying out such a method, to a comfort system having such a footrest system and a vehicle seat system, and to a motor vehicle having such a comfort system.

### BACKGROUND

Nowadays, increasing significance is being given to the comfort of the operator in motor vehicles. The known comfort systems allow a multiplicity of comfort adjustments for interior components such as vehicle seats and footrests. These comfort adjustments can be provided in a manual or motorized manner.

The known method (DE 100 19 856 A1), from which some embodiments proceed, is based on a footrest system having a footrest and having a footrest adjustment system for adjusting the footrest. The footrest system is arranged on a flat portion of the vehicle floor and allows the height of the footrest to be adapted in dependence on the respective height of the motor vehicle seat. However, in the known method the adjustability of the footrest is possible only to a very restricted extent. What is more, the installation space utilization achieved there is extremely low.

### SUMMARY

The present case concerns the sitting comfort of the operator and specifically the comfortable support of the feet of the operator by means of an adjustable footrest. It is particularly the flexible adjustment, adapted to the operator, of a footrest that constitutes a challenge here, in particular when account is taken of the fact that the installation space available for a footrest is extremely tight.

Various embodiments are based on the problem of designing and developing the known method in such a way that flexible adjustment of the footrest with maximum installation space utilization is possible.

The above problem is solved by various features described herein.

What is essential to some embodiments is the basic insight that step offsets in the vehicle floor of a motor vehicle can particularly advantageously be utilized to accommodate an above footrest system. The motor vehicle has a support structure which in a longitudinal direction forms a step offset between a lower support plate and an upper support plate. In the present case, the step offset is the connection between the lower support plate and the upper support plate, and therefore a stepped arrangement is produced overall. Such a step offset can be provided by a heel plate in the vehicle floor.

According to the proposal, it has also been identified that an above step offset, in particular on its side facing away from the assigned motor vehicle seat, provides a good parking position for the footrest when the footrest is not intended to be used. For the use of the footrest, it is then proposed that, in the context of a comfort adjustment, the footrest is adjusted by means of a footrest adjustment system from a parking position on the lower support plate over the step offset to an operating position on the upper support plate. The footrest is thus to some extent adjusted around the step offset into the relevant operating position. Advantageously, this adjustment of the footrest is accompanied by a changing inclination of the footrest in relation to the longitudinal direction, in some cases in such a way that the operator can already place their feet during this adjustment of the footrest.

It is easy to see that the relevant step offset, on its lower side, provides a considerable installation space for the arrangement and/or fastening of the footrest adjustment system. This installation space allows a wide variety of footrest adjustment kinematic systems to be accommodated, such that the trajectory of the footrest can be freely selected in a wide range during its adjustment. In particular, it is possible for the adjustment of the footrest to be performed in dependence on an adjustment of the assigned motor vehicle seat and in particular in dependence on operator data, such as the physical size of the operator.

Various embodiments emphasize that the footrest is located below the upper support plate in the parking position, whilst the footrest is located above the upper support plate in the operating position. In the present case, the position indications, in particular the indications “below” and “above”, always relate to a freely selectable reference point on the footrest.

Various embodiments for the trajectory of the footrest during its adjustment from the parking position to the operating position are provided herein. The step offset can be optimally traversed by virtue of the vertical adjustment component initially predominating and the longitudinal adjustment component in the longitudinal direction predominating only after the upper support plate has been reached by the footrest. If at the same time, the footrest is inclined toward the operator, the footrest can be arranged in a particularly space-saving manner in the parking position. In the case of this inclination toward the operator, what is meant is the operator whose feet are supported on the footrest.

It should be pointed out that the longitudinal direction and the vertical direction are defined exclusively by the step offset. As explained above, the step offset is formed in the longitudinal direction between the lower support plate and the upper support plate. The vertical direction correspondingly results from the offset between the lower support plate and the upper support plate. Accordingly, the orientation of the longitudinal direction within the motor vehicle is independent of the longitudinal axis of the motor vehicle. However, it can be the case that the longitudinal direction runs along the longitudinal axis of the motor vehicle, and/or that the vertical direction runs in the vertical direction of the motor vehicle.

Various embodiments relate to the coordinated movement of the footrest of the footrest system with the vehicle seat of a vehicle seat system. What is of particular significance in the present case is the realization of a comfort position of the motor vehicle seat with a lying backrest, the setting of which is accompanied by a corresponding adjustment of the footrest from the parking position to the respective operating position. With respect to the adjustment of the backrest of the vehicle seat, it is particularly advantageous from a comfort point of view for the inclination of the footrest to be able to be changed as mentioned above. The coupling for the coordinated adjustment of the footrest and of the vehicle seat may be provided mechanically and/or electrically. In the case of electrical coupling, as provided in some embodiments use may advantageously be made of operator data to perform the comfort adjustment. In particular, the distance between the footrest and the vehicle seat may be set in an operator-specific manner, in particular in dependence on the physical size of the operator. It may be particularly advantageous for the footrest to be forcibly adjusted in a manner dependent on the adjustment of the vehicle seat on account of the mentioned coupling.

According to various embodiments, a footrest system for carrying out the proposed method is provided as such.

What is essential for some embodiments is that the footrest system comprises an above footrest and an above footrest adjustment system, wherein the footrest adjustment system is designed in such a way that, in the context of a comfort adjustment, the footrest is adjustable by means of the footrest adjustment system, such as with a changing inclination of the footrest in relation to the longitudinal direction, from a parking position on the lower support plate over the step offset to an operating position on the upper support plate. In this respect, reference may be made to all the statements made regarding the proposed method.

Due to the fact that according to the proposal the footrest adjustment system is responsible for the step offset being traversed by the footrest, there are numerous possibilities for the realization of the footrest adjustment kinematic system, which, as provided in some embodiments, defines the trajectory of the footrest during its adjustment between the parking position and the operating position. In various embodiments, the footrest adjustment kinematic system is designed as a multi-joint kinematic system, such as a four-joint kinematic system, which enables a simple realization and at the same time a flexible designability of the trajectory of the footrest.

Various embodiments relate to the above-mentioned inclination of the footrest in the course of its adjustment. This can be particularly readily implemented with an above-mentioned multi-joint kinematic system, such as a four-joint kinematic system.

In various embodiments, the footrest adjustment system is equipped with a footrest adjustment drive, which in various embodiments comprises a footrest adjustment motor. As an alternative, it is also conceivable for the footrest adjustment drive to be operated manually with operator force, for example by means of a handwheel. It is also conceivable for the footrest as such to be gripped by the operator and adjusted thereby, the footrest adjustment kinematic system ensuring the trajectory of the footrest is maintained.

An installation space-optimized embodiment is provided herein. Here, it is proposed that at least part of the footrest adjustment system be arranged on and/or fastened to the lower side of the support structure and in particular in the region of the step offset. For this, a support structure passage is then further provided in the support structure, such that at least part of the footrest adjustment kinematic system can be coupled to the footrest through the support structure passage.

According to various embodiments, a comfort system for carrying out the proposed method is provided, the problem here relating to the combination of the footrest system with the vehicle seat system. In this respect, reference may be made to all the statements made regarding the two teachings mentioned above.

What is of particular significance in some embodiments is the coordinated adjustment of the footrest with the vehicle seat in the context of the above-mentioned comfort adjustment.

What is of interest in some embodiments is that a support rail system, which is provided for fastening and/or guiding the vehicle seat system, can simultaneously provide at least part of the above-mentioned support structure passage for the footrest adjustment system. This is particularly advantageous since the support structure passage is then not visible to the operator.

According to various embodiments, a motor vehicle having an above comfort system is provided. What is essential for some embodiments is the fact that the motor vehicle has a vehicle floor, which provides the above-mentioned support structure with the lower support plate and the upper support plate. It can be the case that the step offset to be traversed by the footrest is formed from a heel plate in the vehicle floor of the motor vehicle.

Various embodiments provide a method for operating a comfort system of a motor vehicle, wherein the comfort system comprises a footrest system having a footrest for supporting the feet of an operator, wherein the motor vehicle has a support structure which in a longitudinal direction forms a step offset between a lower support plate and an upper support plate, wherein, in the context of a comfort adjustment, the footrest is adjusted by means of a footrest adjustment system, such as with a changing inclination of the footrest in relation to the longitudinal direction, from a parking position on the lower support plate over the step offset to an operating position on the upper support plate.

In various embodiments, in the context of a comfort adjustment, the footrest is adjusted by means of a footrest adjustment system, such as with a changing inclination of the footrest in relation to the longitudinal direction, from a parking position below the upper support plate over the step offset to an operating position above the upper support plate.

In various embodiments, the adjustment of the footrest from the parking position to the operating position comprises a vertical adjustment component in a vertical direction and a longitudinal adjustment component in the longitudinal direction.

In various embodiments, during the adjustment of the footrest from the parking position to the operating position, the vertical adjustment component initially predominates and the longitudinal adjustment component predominates after the upper support plate has been reached.

In various embodiments, a foot bearing surface of the footrest is oriented substantially in the longitudinal direction in the parking position, and in that the foot bearing surface is oriented inclined with respect to the longitudinal direction, in particular inclined toward the operator, in the operating position, such as in that the inclination angle in relation to the longitudinal direction lies between 30° and 60°, and in some embodiments is 50°.

In various embodiments, the comfort system comprises a vehicle seat system having a vehicle seat and a vehicle seat adjustment system for adjusting the vehicle seat, and in that the footrest system and the vehicle seat system are mechanically and/or electrically coupled to one another in such a way that the footrest is adjusted in a manner dependent on the adjustment of the vehicle seat.

In various embodiments, the footrest system and the vehicle seat system are mechanically and/or electrically coupled to one another in such a way that the footrest is forcibly adjusted in a manner dependent on the adjustment of the vehicle seat.

In various embodiments, in the context of a comfort adjustment, the vehicle seat is adjusted by means of the vehicle seat adjustment system from a normal position with an upright backrest to a comfort position with a lying backrest, and in that at the same time the footrest is adjusted by means of the footrest adjustment system from the parking position to the operating position.

In various embodiments, in the context of the comfort adjustment, the vehicle seat is adjusted in the longitudinal direction by means of the vehicle seat adjustment system.

In various embodiments, the comfort system comprises an electronic controller which, in the context of the comfort adjustment, effects motorized adjustment of the vehicle seat by means of the vehicle seat adjustment system and motorized adjustment of the footrest by means of the footrest adjustment system.

In various embodiments, operator data are stored in the electronic controller, and in that the electronic controller performs the comfort adjustment in dependence on the operator data, such as in that the stored operator data include the physical size of the operator.

Various embodiments provide a footrest system for carrying out a method as described herein, wherein the footrest system comprises a footrest and a footrest adjustment system, wherein the footrest adjustment system is designed in such a way that, in the context of a comfort adjustment, the footrest is adjustable by means of the footrest adjustment system, such as with a changing inclination of the footrest in relation to the longitudinal direction, from a parking position on the lower support plate over the step offset to an operating position on the upper support plate.

In various embodiments, the footrest adjustment system comprises a footrest adjustment kinematic system which defines the trajectory of the footrest during its adjustment between the parking position and the operating position.

In various embodiments, the footrest adjustment kinematic system is designed as a lever kinematic system.

In various embodiments, the footrest adjustment kinematic system is designed as a multi-joint kinematic system. In some embodiments, is designed as a four-joint kinematic system. In various embodiments, the footrest adjustment kinematic system is designed in such a way that a foot bearing surface of the footrest is oriented substantially in the longitudinal direction in the parking position and that the foot bearing surface is oriented inclined with respect to the longitudinal direction, in particular inclined toward the operator, in the operating position, such as in that the inclination angle (φ) in relation to the longitudinal direction lies between 30° and 60°, in some embodiments is 50°.

In various embodiments, the footrest adjustment system comprises a footrest adjustment drive which is coupled in terms of drive to the footrest adjustment kinematic system, such that the footrest adjustment drive can be used to effect the adjustment of the footrest between the parking position and the operating position.

In various embodiments, the footrest adjustment drive comprises a footrest adjustment motor for motorized adjustment of the footrest.

In various embodiments, in the mounted state, at least part of the footrest adjustment system is arranged on and/or fastened to a lower side of the support structure, such as in the region of the step offset.

In various embodiments, the support structure has, at least in the region of the step offset, at least one, in particular slot-like support structure passage, and in that the footrest adjustment kinematic system is coupled to the footrest through the at least one support structure passage.

Various embodiments provide a comfort system for carrying out a method as described herein, comprising a footrest system as described herein and a vehicle seat system having a vehicle seat and a vehicle seat adjustment system for adjusting the vehicle seat.

In various embodiments, the footrest system and the vehicle seat system are mechanically and/or electrically coupled to one another in such a way that the footrest is adjusted in a manner dependent on the adjustment of the vehicle seat.

In various embodiments, in the mounted state, a support rail system for fastening and/or guiding the vehicle seat system is provided on the upper support plate, and in that the support rail system provides at least part of the at least one support structure passage for the footrest adjustment system.

Various embodiments provide a motor vehicle having a comfort system as described herein and a vehicle floor which provides the support structure.

### BRIEF DESCRIPTION OF THE DRAWINGS

Various aspects will be explained in more detail below with reference to a drawing illustrating merely an exemplary embodiment. In the drawing:

FIG. 1 shows a proposed motor vehicle having a proposed comfort system composed of footrest system and vehicle seat system for carrying out the proposed method at the beginning of a comfort adjustment in a perspective view,

FIG. 2 shows the comfort system according to FIG. 1 a) during the comfort adjustment and b) after completion of the comfort adjustment, in each case in a perspective view,

FIG. 3 shows the comfort system according to FIG. 1 with a perspective detail illustration of the footrest system, and

FIG. 4 shows the footrest system according to FIG. 3 with a movement sequence of the footrest during the comfort adjustment according to FIGS. 1 and 2 in a side view.

### DETAILED DESCRIPTION

The proposed method relates to the operation of a comfort system 1 of a motor vehicle 2, comprising a footrest system 3 having a footrest 4 for supporting the feet of an operator. The proposed comfort system 1 can, in principle, comprise a plurality of seats each having an assigned footrest 4. For the purpose of a clear illustration, reference is always made only to a single footrest and a single seat in the present case. All the statements made in this regard correspondingly apply to all further footrests and seats.

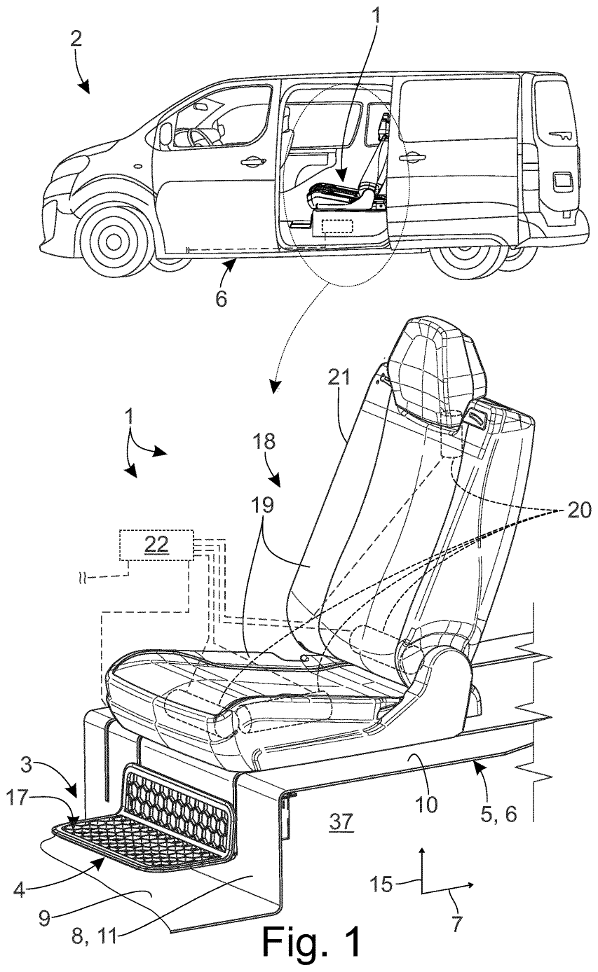

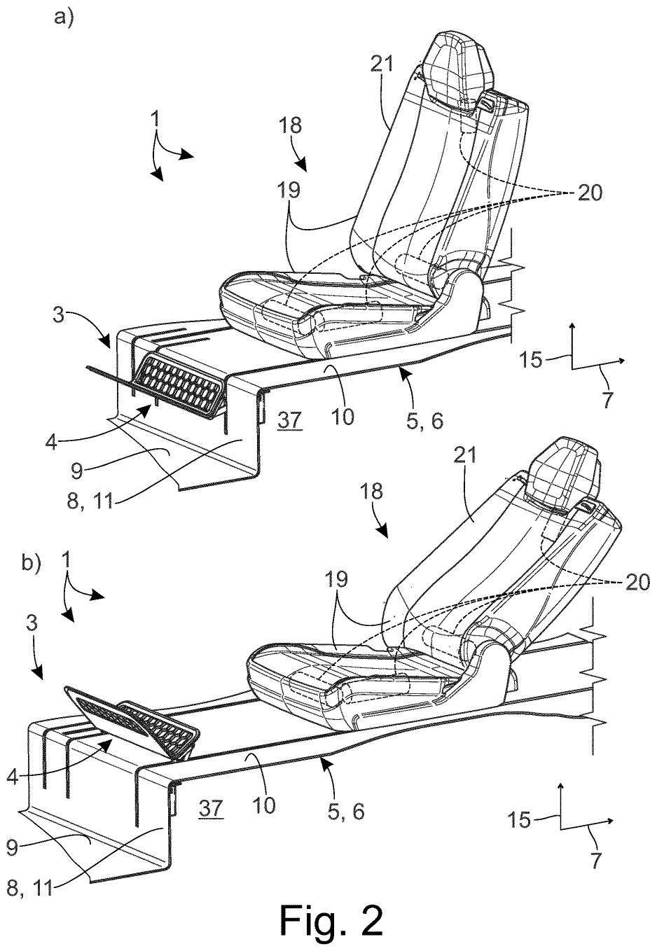

The illustrations according to FIGS. 1 and 2 show the proposed comfort system 1 for carrying out the proposed method in different positions that are still to be explained. It can be gathered from these illustrations that the motor vehicle 2 has a support structure 5 which is a constituent part of a vehicle floor 6. The vehicle floor 6 is usually fitted onto a body floor or is a constituent part of at least part of the body floor. The vehicle floor usually provides the area where the user treads. The support structure 5 forms, in a longitudinal direction 7, a step offset 8 between a lower support plate 9 and an upper support plate 10.

The term “plate” should be interpreted broadly here and also includes multi-wall plates in addition to single-wall plates. Such a plate may be composed of a metal material, in particular steel, and/or of other materials such as plastic. In this case, the step offset 8 is provided by a heel plate 11 of the vehicle floor 6.

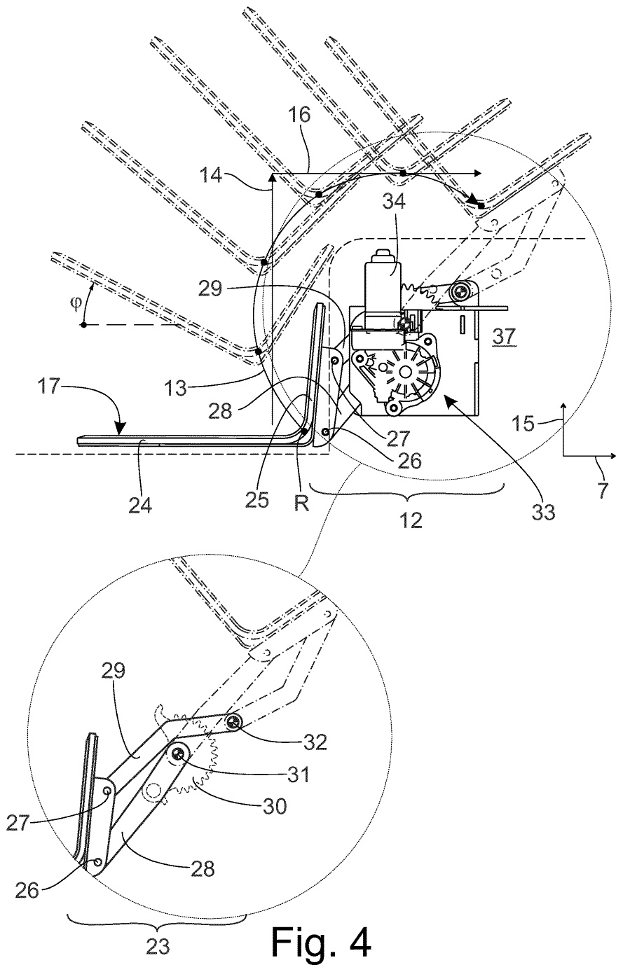

What is essential for some embodiments of the proposed method is the sequence of FIG. 1, FIG. 2a and FIG. 2b, which is also reflected in the illustration according to FIG. 4. Accordingly, in the context of a comfort adjustment, the footrest 4 is adjusted by means of a footrest adjustment system 12 of the footrest system 3 from a parking position (FIG. 1) on the lower support plate 9, such as below the upper support plate 10, over the step offset 8 to an operating position (FIG. 2b) on the upper support plate 10, such as above the upper support plate 10. In the present case, this always means that a reference point R, mentioned further above, of the footrest 4 is situated on the lower support plate 9, such as below the upper support plate 10, in the parking position and on the upper support plate 10, such as above the upper support plate 10, in the operating position. In various embodiments, the reference point R in the side view shown in FIG. 4 is at the vertex of the, in some embodiments, L-shaped footrest 4.

It can be the case that the above adjustment of the footrest 4 is accompanied by a changing inclination φ of the footrest 4 in relation to the longitudinal direction 7, which can be accompanied by a very particular gain in comfort.

Overall, the footrest 4 thus traverses the step offset 8 proceeding from the parking position to the respective operating position. It is clear here that during this adjustment the footrest 4 moves past the step offset 8 in such a way that the installation space present is optimally utilized. In various embodiments, the above adjustment by the footrest adjustment system 12 is possible in the same way in both directions, that is to say also from the operating position to the parking position. The footrest 4 is then adjusted by means of a footrest adjustment system 12, with a changing inclination o of the footrest 4 in relation to the longitudinal direction 7, from the operating position on the upper support plate 10 over the step offset 8 to the parking position on the lower support plate 9. In various embodiments, the change in the inclination φ of the footrest 4 during the course of the comfort adjustment of the footrest 4 is continuous.

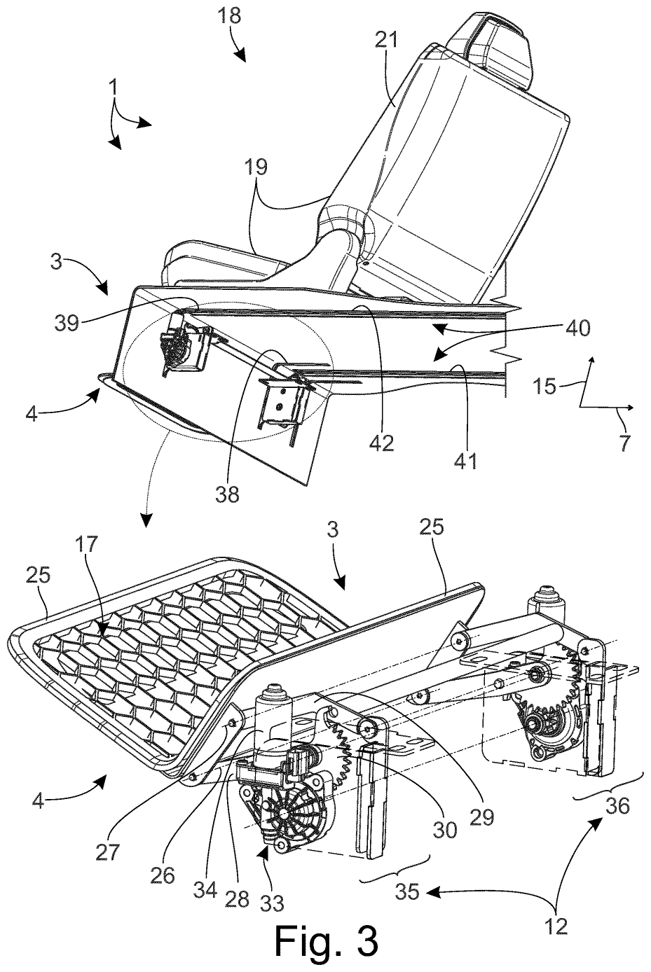

It can be gathered from the illustration according to FIG. 4 that the proposed solution can, in principle, be applied to a multiplicity of different footrests 4. For example, the footrest 4 can be adapted ergonomically and individually to the respective operator. In this case, the footrest 4 may be designed to be elastic, partially elastic, cushioned or the like. In the exemplary embodiment that is shown in FIG. 3, the footrest 4 is at least partially equipped with a honeycomb structure, in order to ensure high robustness with low weight.

The illustration according to FIG. 4 also shows the trajectory 13 of the footrest 4. Here, it is clear that the adjustment of the footrest 4 from the parking position to the operating position comprises a vertical adjustment component 14 in the vertical direction 15 and a longitudinal adjustment component 16 in the longitudinal direction 7. It is apparent here that, during the adjustment of the footrest 4 from the parking position to the operating position, the vertical adjustment component 14 initially predominates and the longitudinal adjustment component 16 predominates after the upper support plate 10 has been reached. With a corresponding design, it is even possible for the adjustment to be effected almost exclusively in the longitudinal direction 7 after the upper support plate 10 has been reached.

The vertical adjustment component of the footrest 4 is essentially dependent on the height of the step offset 8. In various embodiments, the height of the step offset 8 is at least 100 mm, in some embodiments at least 150 mm. Correspondingly, the adjustment of the footrest 4 from the parking position to the operating position comprises a vertical adjustment component of at least 150 mm, in some embodiments of at least 200 mm.

Viewing FIGS. 1 and 4 together also shows that, in various embodiments, a foot bearing surface 17 of the footrest 4 is oriented substantially in the longitudinal direction 7 in the parking position. This means that the foot bearing surface 17 can run along the vehicle floor 6, in particular along the lower support plate 9, in the parking position and thus does not constitute an obstacle for the operator when getting in and out of the vehicle. The inclination angle φ in relation to the longitudinal direction 7 can then be zero. Provision may even further be made for the footrest 4 with its foot bearing surface 17 to be at least partially arranged in a recess in the vehicle floor 6 in the parking position.

In the operating position, the foot bearing surface 17 can be oriented inclined with respect to the longitudinal direction 7, wherein the inclination angle φ in relation to the longitudinal direction 7 can lie between 30° and 60°and in particular is 50°. This inclination of the foot bearing surface 17 can be oriented toward the operator using the footrest 4. Depending on the structural design of the footrest adjustment system 12, the operating position can be varied in the longitudinal direction 7 and/or in the vertical direction 15 and/or with regard to the inclination angle φ.

The proposed comfort system 1 can include a vehicle seat system 18, wherein a coordinated movement between the footrest system 3 and the vehicle seat system 18 is provided. The vehicle seat system 18 comprises a vehicle seat 19 and a vehicle seat adjustment system 20 for adjusting the vehicle seat 19. The footrest system 3 and the vehicle seat system 18 are mechanically and/or electrically coupled to one another in such a way that the footrest 4 is adjusted, in some embodiments is forcibly adjusted, in a manner dependent on the adjustment of the vehicle seat 19. This is very generally a coupling using control technology. In various embodiments, the adjustment of the vehicle seat 19 and of the footrest 4 takes place at the same time. For this, the adjustment speeds can correspondingly be matched to one another.

One example of coordinated adjustment of the footrest 4 and of the vehicle seat 19 takes place in the context of a specific lying comfort adjustment. Here, the vehicle seat 19 is adjusted by means of the vehicle seat adjustment system 20 from a normal position (FIG. 1) with an upright backrest 21 via an intermediate position (FIG. 2a) to a comfort position (FIG. 2b) with a lying backrest 21. The term “upright” should be understood to mean that the operator seated on the vehicle seat 19 is in the sitting position. The term “lying” should be understood to mean that the operator seated on the vehicle seat 19 is in the lying position. In various embodiments, in the context of this comfort adjustment, the vehicle seat 19 is additionally adjusted in the longitudinal direction 7 by means of the vehicle seat adjustment system 20.

It can then be the case that at the same time as the above adjustment of the vehicle seat 19, the footrest 4 is adjusted by means of the footrest adjustment system 12 from the parking position to the operating position.

The above-mentioned coordinated adjustment between the footrest 4 and the vehicle seat 19 can be implemented particularly flexibly using electronic control technology. For this, the comfort system 1 can be equipped with an electronic controller 22 which, in the context of the comfort adjustment, effects motorized adjustment of the vehicle seat 19 by means of the vehicle seat adjustment system 20 and, in some embodiments coordinated therewith, motorized adjustment of the footrest 4 by means of the footrest adjustment system 12. Operator data such as the physical size of the operator can be stored in the controller 22. The comfort adjustment is then performed, controlled by the electronic controller 22, in dependence on the respective operator data. This relates in particular to the degree of adjustment of the footrest 4 and of the vehicle seat 19 in the longitudinal direction 7, in order to take account of the physical size of the user.

As an alternative or in addition, the electronic controller 22 may be coupled to an operator interface, via which operator inputs are possible. Via the operator interface, it can be possible to perform separate motorized adjustment of the footrest 4 and/or the vehicle seat 19 in a targeted manner.

According to a further teaching, the proposed footrest system 3 is provided as such. As explained above, the footrest system 3 comprises a footrest 4 and a footrest adjustment system 12, wherein the footrest adjustment system 12 is designed in such a way that, in the context of a comfort adjustment, the footrest 4 is adjustable by means of the footrest adjustment system 12, such as with a changing inclination φ of the footrest 4 in relation to the longitudinal direction 7, from a parking position on the lower support plate 9 over the step offset 8 to an operating position on the upper support plate 10. In this respect, reference may be made to all the statements made regarding the proposed method.

The footrest adjustment system 12 can include a footrest adjustment kinematic system 23 which defines the trajectory 13 of the footrest 4 during its adjustment between the parking position and the operating position. In various embodiments, the footrest adjustment kinematic system 23 is designed as a lever kinematic system and in particular as a multi-joint kinematic system, such as a four-joint kinematic system. The footrest adjustment kinematic system 23 is apparent from viewing FIGS. 3 and 4 together. For the optimal coupling to the footrest adjustment kinematic system 23, the footrest 4 is of L-shaped design in cross section. Accordingly, the footrest 4 can have a foot bearing part 24, comprising the foot bearing surface 17, and a coupling part 25 arranged transversely with respect thereto. The coupling part 25 is coupled to a drive lever 28 and to a guide lever 29 of the footrest adjustment kinematic system 23 via two coupling axes 26, 27 that are spaced apart from one another. The drive lever 28 is connected in terms of drive to a drive wheel 30, and therefore the drive lever 28 is drivable with the drive wheel 30 about a drive wheel axis 31. One end of the guide lever 29 is articulated to the coupling axis 27. The other end of the guide lever 29 is articulated to a positionally fixed coupling axis 32. As a result, an adjustment of the drive wheel 30 in FIG. 4 in a clockwise direction effects an adjustment of the footrest 4 around the step offset 8. Here, the inclination of the footrest 4 changes in relation to the longitudinal direction 7, as already explained above, such as continuously.

In various embodiments, a footrest adjustment drive 33 is provided for driving the drive wheel 30 and can be used to effect the adjustment of the footrest 4 between the parking position and the operating position. In various embodiments, it is the case that the footrest adjustment drive 33 comprises a footrest adjustment motor 34 for motorized adjustment of the footrest 4.

In the exemplary embodiment that is illustrated, the footrest adjustment system 12 is equipped with two adjustment units 35, 36. The first adjustment unit 35 comprises the footrest adjustment kinematic system 23 and the footrest adjustment drive 33, with assigned footrest adjustment motor 34, which is coupled thereto in terms of drive. The second adjustment unit 36 is of identical construction. The two adjustment units 35, 36 are arranged on opposite sides of the footrest 4, such that a robust adjustment of the footrest 4 is ensured.

Both adjustment units 35, 36 are of self-locking design, such that an adjustment of the footrest 4 is blocked when the footrest adjustment motor 34 is deactivated. In principle, a non-self-locking design of the adjustment units 35, 36 is also conceivable, such that manual adjustment of the footrest 4 by introduction of a minimum operator force into the footrest 4 can be effected.

The illustration according to FIG. 4 shows that, in the mounted state, at least part of the footrest adjustment system 12 is arranged on and/or fastened to a lower side 37 of the support structure 5, in this case in the region of the step offset 8. In this way, the installation space both on the upper side and on the lower side of the support structure 5 is optimally utilized. For the coupling between the footrest adjustment system 12 and the footrest 4, provision can be made for the support structure 5 to have, at least in the region of the step offset 8, at least one, in this case slot-like support structure passage 38, 39, wherein the footrest adjustment kinematic system 23 is coupled to the footrest 4 through the at least one support structure passage 38, 39. In various embodiments, two support structure passages 38, 39 are provided for the footrest 4, through which the adjustment units 35, 36 are each coupled to the footrest 4. On the upper support plate 10, the support structure passages 38, 39 run in the longitudinal direction 7.

In principle, the footrest adjustment system 12 may also be arranged and/or fastened above the support structure 5. This may be advantageous when realizing a particularly flat construction of the footrest adjustment system 12.

According to a further teaching, the comfort system 1 is provided as such. In this respect, reference may also be made to all the statements made regarding the teachings mentioned above.

As mentioned above, the comfort system 1 comprises a footrest system 3 and a vehicle seat system 18 having a vehicle seat 19 and a vehicle seat adjustment system 20 for adjusting the vehicle seat 19.

Looking at the illustration according to FIG. 2, what is of interest in the proposed comfort system 1 is that the footrest system 3 and the vehicle seat system 18 are designed and/or mountable mechanically separately from one another, except for a possible above-mentioned coupling using control technology. This results not only in the greatest possible flexibility during the adjustment of footrest 4 and vehicle seat 19, but the footrest system 3 and the vehicle seat system 18 can be produced, and their function tested, separately from one another.

In various embodiments, it is the case that, in the mounted state, a support rail system 40 for fastening and/or guiding the vehicle seat system 18 is provided on the upper support plate 10. In this case, the support rail system 40 comprises two support rails 41, 42 for the vehicle seat 19, which are each oriented in the longitudinal direction 7. In this case, the support rail system 40, according to FIG. 2 the support rail 42 of the support rail system 40, provides at least part of the at least one support structure passage 39 for the footrest adjustment system 12. Specifically, the support rails 41, 42 each comprise a groove-like form in the upper support plate 10. The support rail 42 is pierced to produce the support structure passage 39, such that although the support structure passage 39 is present, it is advantageously not visible from the outside.

According to a further teaching, a motor vehicle 2 having a proposed comfort system 1 is provided. The proposed motor vehicle 2 has a vehicle floor 6 which provides the above-mentioned support structure 5. The lower support plate 9 and the upper support plate 10 form the step offset 8. In this respect, reference may also be made to all the explanations given regarding the teachings mentioned above.

1. A method for operating a comfort system of a motor vehicle, wherein the comfort system comprises a footrest system comprising a footrest for supporting the feet of an operator, wherein the motor vehicle comprises a support structure which in a longitudinal direction forms a step offset between a lower support plate and an upper support plate wherein, in the context of a comfort adjustment, the footrest is adjusted by a footrest adjustment system from a parking position on the lower support plate over the step offset to an operating position on the upper support plate.

2. The method as claimed in claim 1, wherein in the context of a comfort adjustment, the footrest is adjusted by a footrest adjustment system from a parking position below the upper support plate over the step offset to an operating position above the upper support plate.

3. The method as claimed in claim 1 wherein the adjustment of the footrest from the parking position to the operating position comprises a vertical adjustment component in a vertical direction and a longitudinal adjustment component in the longitudinal direction.

4. The method as claimed in claim 1, wherein during the adjustment of the footrest from the parking position to the operating position, the vertical adjustment component initially predominates and the longitudinal adjustment component predominates after the upper support plate has been reached.

5. The method as claimed in claim 1, wherein a foot bearing surface of the footrest is oriented substantially in the longitudinal direction in the parking position, and wherein the foot bearing surface is oriented inclined with respect to the longitudinal direction in the operating position.

6. The method as claimed in claim 1, wherein the comfort system comprises a vehicle seat system comprising a vehicle seat and a vehicle seat adjustment system for adjusting the vehicle seat, and wherein the footrest system and the vehicle seat system are mechanically and/or electrically coupled to one another in such a way that the footrest is adjusted in a manner dependent on the adjustment of the vehicle seat.

7. The method as claimed in claim 6, wherein the footrest system and the vehicle seat system are mechanically and/or electrically coupled to one another in such a way that the footrest is forcibly adjusted in a manner dependent on the adjustment of the vehicle seat.

8. The method as claimed in claim 1, wherein, in the context of a comfort adjustment, the vehicle seat is adjusted by the vehicle seat adjustment system from a normal position with an upright backrest to a comfort position with a lying backrest, and wherein at the same time the footrest is adjusted by the footrest adjustment system from the parking position to the operating position.

9. The method as claimed in claim 1, wherein, in the context of the comfort adjustment, the vehicle seat is adjusted in the longitudinal direction by the vehicle seat adjustment system.

10. The method as claimed in claim 1, wherein the comfort system comprises an electronic controller which, in the context of the comfort adjustment, effects motorized adjustment of the vehicle seat by the vehicle seat adjustment system and motorized adjustment of the footrest by the footrest adjustment system.

11. The method as claimed in claim 10, wherein operator data are stored in the electronic controller, and wherein the electronic controller performs the comfort adjustment in dependence on the operator data.

12. A footrest system for carrying out a method as claimed in claim 1, wherein the footrest system comprises a footrest and a footrest adjustment system, wherein the footrest adjustment system is designed in such a way that, in the context of a comfort adjustment, the footrest is adjustable by the footrest adjustment system from a parking position on the lower support plate over the step offset to an operating position on the upper support plate.

13. The footrest system as claimed in claim 12, wherein the footrest adjustment system comprises a footrest adjustment kinematic system which defines the trajectory of the footrest during its adjustment between the parking position and the operating position.

14. The footrest system as claimed in claim 13, wherein the footrest adjustment kinematic system is designed as a lever kinematic system.

15. The footrest system as claimed in claim 13, wherein the footrest adjustment kinematic system is designed as a multi-joint kinematic system.

16. The footrest system as claimed in claim 13, wherein the footrest adjustment kinematic system is designed in such a way that a foot bearing surface of the footrest is oriented substantially in the longitudinal direction in the parking position and that the foot bearing surface is oriented inclined with respect to the longitudinal direction in the operating position.

17. The footrest system as claimed in claim 13, wherein the footrest adjustment system comprises a footrest adjustment drive which is coupled in terms of drive to the footrest adjustment kinematic system, such that the footrest adjustment drive can be used to effect the adjustment of the footrest between the parking position and the operating position.

18. The footrest system as claimed in claim 17, wherein the footrest adjustment drive comprises a footrest adjustment motor for motorized adjustment of the footrest.

19. The footrest system as claimed in claim 1, wherein, in the mounted state, at least part of the footrest adjustment system is arranged on and/or fastened to a lower side of the support structure.

20. The footrest system as claimed in claim 13, wherein the support structure comprises, at least in the region of the step offset, at least one, in particular slot-like support structure passage, and wherein the footrest adjustment kinematic system is coupled to the footrest through the at least one support structure passage.

21. A comfort system for carrying out a method as claimed in claim 1, comprising a footrest system and a vehicle seat system comprising a vehicle seat and a vehicle seat adjustment system for adjusting the vehicle seat.

22. The comfort system as claimed in claim 21, wherein the footrest system and the vehicle seat system are mechanically and/or electrically coupled to one another in such a way that the footrest is adjusted in a manner dependent on the adjustment of the vehicle seat.

23. The comfort system as claimed in claim 21, wherein, in the mounted state, a support rail system for fastening and/or guiding the vehicle seat system is provided on the upper support plate, and in that the support rail system provides at least part of the at least one support structure passage for the footrest adjustment system.

24. A motor vehicle comprising a comfort system as claimed in claim 21 and a vehicle floor which provides the support structure.
